(19) United States
(12) Patent Application Publication
(10) Pub. No.: US 2015/0106274 A1
(43) Pub. Date: Apr. 16, 2015

(54) CREDIT CARD SECURITY ENHANCEMENTS FOR AUTHORIZING A CREDIT CARD TRANSACTION

(71) Applicant: Xerox Corporation, Norwalk, CT (US)

(72) Inventors: ALBERTO RODRIGUEZ, Webster, NY (US); Heiko Rommelmann, Penfield, NY (US)

(73) Assignee: Xerox Corporation, Norwalk, CT (US)

(21) Appl. No.: 14/052,261

(22) Filed: Oct. 11, 2013

(51) Int. Cl. G06Q 20/40; G06Q 20/24

(52) U.S. Cl. CPC G06Q 20/4012; G06Q 20/24
USPC 705/72

(57) ABSTRACT

A method, non-transitory computer readable medium, and apparatus for authorizing a credit card transaction are disclosed. For example, the method receives a request to validate a transaction with a vendor using a credit card account, sends a request to an owner of the credit card account for a personal identification number (PIN) associated with the credit card account, wherein the PIN comprises one or more parameters, receives the PIN, determines that the PIN matches one of one or more PINs that were generated and associated with the credit card account and that each one of the one or more parameters associated with the PIN is met by the transaction and authorizes the transaction with the vendor using the credit card account.

The present disclosure relates generally to credit card security and, more particularly, to a method and an apparatus for providing credit card security enhancements for authorizing a credit card transaction.

### BACKGROUND

As of 2006 credit card fraud hit 7% of all credit card transactions. Credit card fraud costs merchants hundreds of billions of dollars annually. Credit card fraud is even easier to commit for customer not present transactions (e.g., online transactions).

Typically, to commit credit card fraud one only needs to steal the static information available on the credit card. Some perpetrators steal the information in the magnetic strip or the printed information directly off of the credit card itself. This information is easily compromised as it is readily visible and readable from the card, thereby, leading to potential credit card fraud.

### SUMMARY

According to aspects illustrated herein, there are provided a method, a non-transitory computer readable medium, and an apparatus for authorizing a credit card transaction. One disclosed feature of the embodiments is a method that receives a request to validate a transaction with a vendor using a credit card account, sends a request to an owner of the credit card account for a personal identification number (PIN) associated with the credit card account, wherein the PIN comprises one or more parameters, receives the PIN, determines that the PIN matches one of one or more PINs that were generated and associated with the credit card account and that each one of the one or more parameters associated with the PIN is met by the transaction and authorizes the transaction with the vendor using the credit card account.

Another disclosed feature of the embodiments is a non-transitory computer-readable medium having stored thereon a plurality of instructions, the plurality of instructions including instructions which, when executed by a processor, cause the processor to perform operations that receives a request to validate a transaction with a vendor using a credit card account, sends a request to an owner of the credit card account for a personal identification number (PIN) associated with the credit card account, wherein the PIN comprises one or more parameters, receives the PIN, determines that the PIN matches one of one or more PINs that were generated and associated with the credit card account and that each one of the one or more parameters associated with the PIN is met by the transaction and authorizes the transaction with the vendor using the credit card account.

Another disclosed feature of the embodiments is an apparatus comprising a processor and a computer readable medium storing a plurality of instructions which, when executed by the processor, cause the processor to perform an operation that receives a request to validate a transaction with a vendor using a credit card account, sends a request to an owner of the credit card account for a personal identification number (PIN) associated with the credit card account, wherein the PIN comprises one or more parameters, receives the PIN, determines that the PIN matches one of one or more PINs that were generated and associated with the credit card account and that each one of the one or more parameters associated with the PIN is met by the transaction and authorizes the transaction with the vendor using the credit card account.

### BRIEF DESCRIPTION OF THE DRAWINGS

The teaching of the present disclosure can be readily understood by considering the following detailed description in conjunction with the accompanying drawings, in which:

FIG. 1 illustrates an example communication network;

FIG. 2 illustrates an example flowchart of a method for authorizing a credit card transaction; and

FIG. 3 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer-readable medium for authorizing a credit card transaction. As discussed above, to commit credit card fraud one only needs to steal the static information available on the credit card. Some perpetrators steal the information in the magnetic strip or the printed information directly off of the credit card itself.

One embodiment of the present disclosure provides a method and apparatus for providing credit card security enhancements for authorizing a credit card transaction. In one embodiment, personal identification numbers (PINs) may be generated to require users to provide a PIN having various parameters that must be met (e.g., a vendor specific PIN) to approve a credit card transaction with a vendor. In addition, dynamic single use credit card numbers may be randomly generated and used. As a result, even if the information that is visible on the credit card is stolen, a perpetrator may not be able to make a transaction to commit credit card fraud.

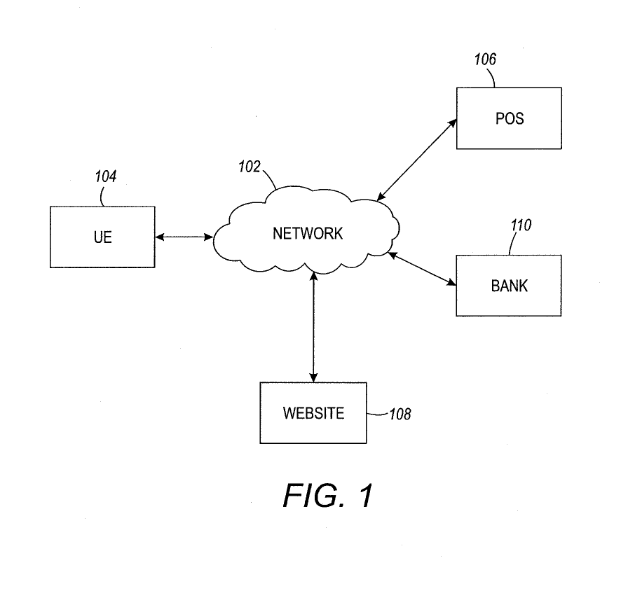

FIG. 1 illustrates an example communication network 100 for authorizing a credit card transaction. In one embodiment, the communication network 100 may include a user endpoint (UE) 104, a point of sale (POS) location 106, a website 108, a credit card service provider or bank 110 all in communication with one another via an Internet protocol (IP) network 102.

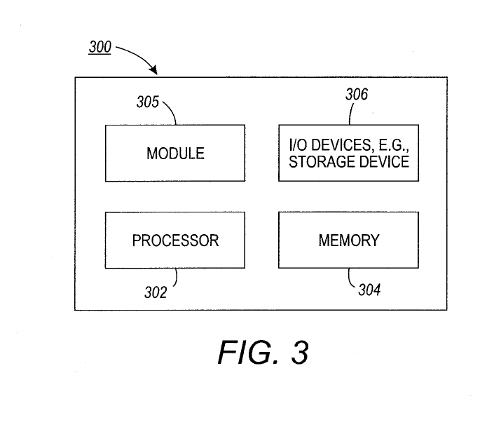

In one embodiment, the IP network 102 may include one or more access networks and network elements (e.g., application servers, border elements, firewalls, gateways, and the like) which are not shown in FIG. 1 for simplicity. In one embodiment, a server or general purpose computer illustrated in FIG. 3 and discussed below may be located at the POS 106, the website 108 and/or the bank 110.

In one embodiment, the UE 104 may be, for example, a desktop computer, a laptop computer, a smartphone, a mobile telephone, a netbook computer, a tablet computer, and the like. Although only a single UE 104, a single POS 106, a single website 108 and a single bank 110 are illustrated in FIG. 1 any number of user endpoints, point of sales, websites and banks may be deployed.

In one embodiment, the POS 106 may be any location where a customer may go to make a transaction in person. For example, the POS 106 may be a brick and mortar retail store or location.

In one embodiment, the website 108 may be any online retailer or website where a customer need not be present to make a purchase. In other words, the website 108 represents a point where customer not present (CNP) transactions may occur, e.g., where only credit card information is submitted without the presence of the credit card owner.

In one embodiment, the customer may have a credit card that is issued or serviced by the bank 110. In one embodiment, the customer or owner of the credit card may request credit card security enhancements for his or her credit card(s). For example, the customer may use the UE 104 to log into a website of the bank 110 using the customer's log in and password credentials previously established with the bank 110.

The customer may then request, for each credit card that he or she owns, that one or more personal identification numbers (PINs) be established with one or more parameters associated with each one of the one or more PINs. In one embodiment, each PIN may comprise any number of digits (e.g., four). In one embodiment, each PIN may be customized by the customer or may be randomly generated by the bank 110.

In one embodiment, the one or more parameters may be a specific vendor associated with each one of the one or more PINs. In other words, each credit card of the customer may be enhanced with a vendor specific PIN. For example, when the customer performs a transaction on the website 108 of a first vendor, the credit card that is used for the transaction must have a PIN that is assigned for the first vendor or the transaction will not be authorized. However, if the same credit card is used for a transaction with a second vendor that is different than the first vendor, the same PIN used for the first vendor cannot be used to complete a transaction with the second vendor. Rather, a different PIN assigned to the second vendor must be provided to authorize the transaction.

In one embodiment, other parameters may be associated with each one of the one or more PINs. For example, the PIN may be designated as a default PIN with a limited number of uses. The default PIN allows a customer to enter a general PIN for all vendors in case he or she is unable to remember a PIN for a specific vendor. The default PIN may have a limited number of uses before a new default PIN must be created to prevent a customer from relying solely on the default PIN.

In one embodiment, an authorized time range parameter may be associated with each one of the one or more PINs. In other words, the PINs may be time delimited. For example, the user may know that they are typically asleep from 11:00 PM to 7:00 AM Eastern Standard Time (EST) Monday-Friday and 1:00 AM-10:00 AM EST Saturday and Sunday. These time ranges may be associated with the PINs as invalid transaction times. In other words, any transactions occurring within these time ranges are to be deemed invalid even if one were to somehow steal the vendor specific PINs associated with the customer's credit card. Furthermore, the customer may be notified by the bank 110 that a transaction was attempted at this time and the customer's credit card information could be compromised.

In one embodiment, a list of authorized users parameter may be associated with each one of the one or more PINs. For example, a credit card owner may issue secondary cards to family members such as his or her spouse and/or children. The list of authorized users parameter may specify which secondary card users are authorized to complete a transaction with the vendor specific PINs. For example, if the children are not authorized, the children could not complete a transaction with the credit card even if they knew the primary account holder's vendor specific PINs associated with the credit card.

In one embodiment, the list of authorized users could be further delimited for each one of the one or more PINs. For example, the primary account holder may authorize his or her children to use the secondary card at a grocery store. As a result, the PIN specific for the grocery store may list the children as authorized users. However, the primary account holder may not authorize his or her children to use the secondary card at an online retailer. Thus, the children could only use the secondary card for purchases made at the grocery store and any transactions attempted with the online retailer would be denied.

It should be noted that other parameters may be associated with the one or more parameters not discussed above. The above examples of parameters are illustrative examples and should not be considered limiting.

In one embodiment, the credit card security enhancements may also include a single use credit card number. In one embodiment, the single use credit card number may be randomly generated or customized by the customer or owner of the credit card.

In one embodiment, the single use credit card number may be used such that the real credit card information is never revealed. As a result, even if one were to steal the single use credit card number from a transaction, the single use credit card number could never be used again. In one embodiment, the single use credit card number may be used in conjunction with the one or more PINs.

After the credit card security enhancements are completed with the bank 110, the user may then use the credit card security enhancements to authorize credit card transactions. For example, a customer may go to ABC company's website 108 using his or her UE 104 via the IP network 102. The customer decides to make a purchase and wants to use the credit card with the security enhancements to complete the purchase. The customer submits the credit card information and personal information to authorize the transaction.

In one embodiment, the website 108 would be required to forward that information to the bank 110 to authorize the transaction. The bank 110 may then in parallel send a request for a PIN to the customer. The request may be sent via an email, a text message, a push notification, a telephone call, and the like. In one embodiment, the request for the PIN may be sent to the same UE 104 used to make the purchase at ABC company's website 108.

In another embodiment, the request for the PIN may be sent to a device different than the UE 104. For example, if the customer is on ABC company's website 108 using a desktop computer, a text message may be sent to the customer's cell phone or smart phone.

In one embodiment, the request for the PIN may serve a dual purpose. The request for the PIN may serve as a notification to the customer in addition to requesting a PIN from the customer. For example, if one were trying to make an unauthorized transaction with stolen credit card information, the customer may be notified and realize a transaction is occurring that was not initiated by the customer. As a result, the customer may quickly cancel his or her credit card and notify the bank 110 that his or her credit card information may have been compromised.

However, if the transaction was initiated by the customer, the customer may respond to the request with the PIN that is specific for ABC company. In one embodiment, the response may be sent via the same method the request was sent from the bank 110. In another embodiment, the customer may send the response in a different form of communication.

The bank 110 may receive the PIN from the customer and if the PIN is the correct PIN for ABC company that was previously registered, the transaction may be authorized. In one embodiment, if a PIN is not received from the customer within a predefined amount of time, the request may time out and the transaction may be denied.

In one embodiment, the bank 110 may verify all of the parameters associated with the PIN. In other words, if multiple parameters are associated with the credit card then the bank 110 may verify that all of the parameters are met. For example, if the customer is a spouse of the primary account holder, the bank 110 may verify that the spouse is an authorized user of the PIN for ABC company. In addition, if the PIN is time delimited, the bank 110 may verify that the transaction is occurring within an allowable time range that was specified during registration of the credit card security enhancements.

In one embodiment, if the single use credit card number is also used, the single use credit card number may be provided to the bank 110. The bank 110 may then verify that the single use credit card number has never been used before in association with the credit card of the customer before the request for the PIN is sent to the customer.

For example, it may be possible that the same single use credit card number is used with a different credit card account. However, for each credit card account, the single use credit card number may be used only once.

If the single use credit card number has been used before in association with the credit card, then the card then the transaction may be unauthorized. Thus, the transaction is denied and a notification may be sent to the customer that someone attempted to use a previously used single use credit card number for a transaction with ABC company.

However, if single use credit card number was never used before in association with the credit card, then the bank 110 may proceed to send a request to the customer for a PIN associated with ABC company. If the transaction is successfully completed, the bank 110 may record the single use credit card number used in the transaction in the credit card account such that the same credit card number is not issued again for single use.

The PIN and the single use credit card number may also be used when the customer is present at a POS 106, e.g., a brick and mortar retailer. For example, a temporary card with the single use credit card number may be issued and the PIN may be entered via the keypad of the credit card swiping device at the POS 106.

Thus, the present disclosure provides credit card security enhancements to authorize credit card transactions. Using the embodiments of the present disclosure, credit card fraud may be prevented even if credit card information is stolen off of a credit card. The parallel request for a PIN to the customer provides notification to the customer that a transaction is occurring that may alert the customer to an unauthorized transaction indicating that his or her credit card information may have been compromised.

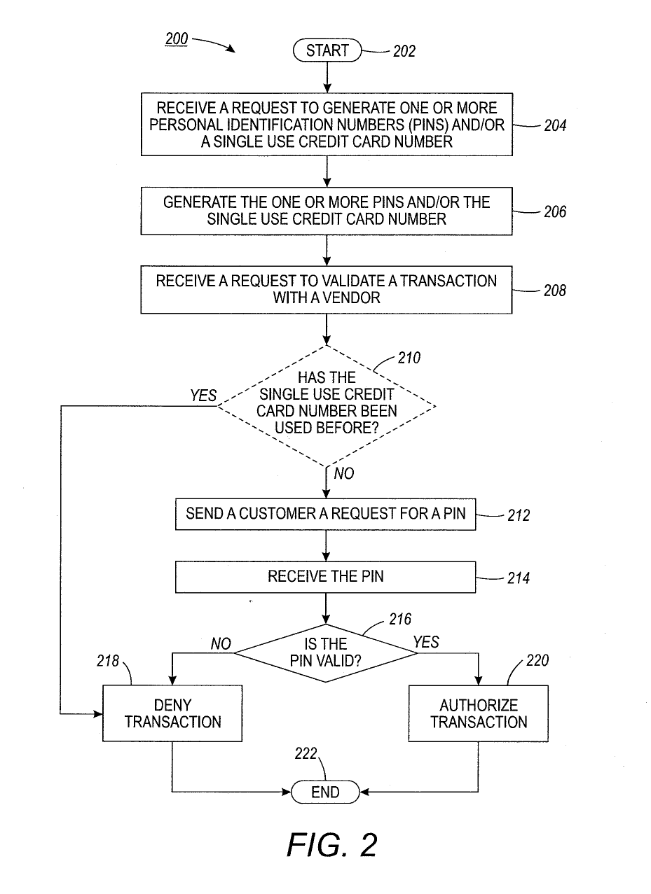

FIG. 2 illustrates a flowchart of a method 200 for authorizing a credit card transaction. In one embodiment, one or more steps or operations of the method 200 may be performed by a server of the credit card service provider 110 or a general-purpose computer as illustrated in FIG. 3 and discussed below of the credit card service provider.

The method 200 begins at step 202. At step 204, the method 200 receives a request to generate one or more personal identification numbers (PINs) and/or a single use credit card number. For example, a customer or owner of a credit card may log into a website of a bank or service provider of the credit card and request credit card security enhancements be registered and stored in association with his or her credit card.

At step 206, the method 200 generates the one or more PINs and/or the single use credit card number. As discussed above, for each credit card, one or more PINs can be established with one or more parameters associated with each one of the one or more PINs.

In one embodiment, the one or more parameters may be a specific vendor associated with each one of the one or more PINs. In other words, each credit card of the customer may be enhanced with a vendor specific PIN.

In one embodiment, other parameters may be associated with each one of the one or more PINs. For example, the PIN may be designated as a default PIN with a limited number of uses. The default PIN allows a customer to enter a general PIN for all vendors in case he or she is unable to remember a PIN for a specific vendor. The default PIN may have a limited number of uses before a new default PIN must be created to prevent a customer from relying solely on the default PIN.

In one embodiment, an authorized time range parameter may be associated with each one of the one or more PINs. In other words, the PINs may be time delimited. For example, the user may know they are typically asleep from 11:00 PM to 7:00 AM EST Monday-Friday and 1:00 AM-10:00 EST AM Saturday and Sunday. These time ranges may be associated with the PINs as invalid transaction times. In other words, any transactions occurring within these time ranges are to be invalid even if one were to somehow steal the vendor specific PINs associated with the customer's credit card. Furthermore, the customer may be notified by the bank that a transaction was attempted at this time and the customer's credit card information could be compromised.

In one embodiment, a list of authorized users parameter may be associated with each one of the one or more PINs. For example, a credit card owner may issue secondary cards to family members such as his or her spouse and/or children. The list of authorized users parameter may specify which secondary card users are authorized to complete a transaction using one or more of the PINs each associated with a different vendor. For example, if the children are not authorized, the children could not complete a transaction with the credit card even if they knew the primary account holder's vendor specific PINs associated with the credit card.

In one embodiment, the list of authorized users could be further delimited for each one of the one or more PINs. For example, the primary account holder may authorize his or her children to use the secondary card at a grocery store. As a result, the PIN specific for the grocery store may list the children as authorized users. However, the primary account holder may not authorize his or her children to use the secondary card at an online retailer. Thus, the children could only use the secondary card for purchases made at the grocery store and any transactions attempted with the online retailer would be denied.

In one embodiment, the credit card security enhancements may also include a single use credit card number. In one embodiment, the single use credit card number may be randomly generated or customized by the customer or owner of the credit card.

In one embodiment, the single use credit card number may be used such that the real credit card information is never revealed. As a result, even if one were to steal the single use credit card number from a transaction, the single use credit card number could never be used again. In one embodiment, the single use credit card number may be used in conjunction with the one or more PINs.

Once the credit card security enhancements are generated the PINs and/or single use credit card number may be stored on the database of the bank. The stored PINs and associated parameters for each one of the PINs may be matched against PINs received from a customer to authorize a transaction.

At step 208, the method 200 receives a request to validate a transaction with a vendor. For example, after the credit card security enhancements are completed, the owner of the credit card may then use the credit card to perform a transaction on a website or at a POS of a brick and mortar retailer. To complete the purchase, the vendor may request the customer enter his or her credit card information and personal information to complete the transaction. The submitted information may then be forwarded to the bank to request validation of the transaction.

At optional step 210, the method 200 may determine whether the single use credit card number has been used before. For example, single use credit card numbers may be optionally used in conjunction with the one or more PINs as an added security enhancement of the credit card. The bank may verify that the single use credit card number has never been used in association with the credit card that is currently being used. For example, it may be possible that the same single use credit card number is used with a different credit card account. However, for each credit card account, the single use credit card number may be used only once.

If the single use credit card number has been used before in association with the credit card currently being used for the pending transaction, the method 200 proceeds to step 218, where the transaction is denied. The method 200 then proceeds to step 222 where the method 200 ends.

However, at optional step 210, if the single use credit card number has never been used before in association with the credit card currently being used for the pending transaction, the method 200 proceeds to step 212. At step 212, the method 200 sends a customer a request for a PIN.

At step 212, the method 200 sends a customer a request for a PIN. The request may be sent via an email, a text message, a push notification, a telephone call and the like.

In one embodiment, the request for the PIN may serve a dual purpose. The request for the PIN may serve as a notification to the customer in addition to requesting a PIN from the customer. For example, if one were trying to make an unauthorized transaction with stolen credit card information, the customer may be notified and realize a transaction is occurring that was not initiated by the customer. As a result, the customer may quickly cancel his or her credit card and notify the bank 110 that his or her credit card information may have been compromised.

At step 214, the method 200 receives the PIN from the customer. In one embodiment, the response may be sent via the same method the request was sent from the bank. In another embodiment, the customer may send the response in a different form of communication.

At step 216, the method 200 determines if the PIN is valid. For example, the bank may verify that the PIN matches the one or more PINs that were generated and registered in step 206 and that each one of the one or more parameters associated with the PIN are met. For example, one of the parameters of the PIN may specify that the PIN is only valid for ABC company. Thus, the bank may verify that the authorization request is from ABC company. Another parameter of the PIN may specify that the transaction may only occur between 8:00 AM-10:00 PM EST seven days a week. Thus, the bank may verify the time of the authorization request falls within the allowable time range. Yet another parameter of the PIN may specify which users of the credit card account are authorized to use which PINs. Thus, the bank may verify that the name of the person requesting the authorization of the transaction is an authorized user of the PIN for this particular vendor.

If the PIN is valid (e.g., all of the parameters associated with the PIN are met) at step 216, the method 200 proceeds to step 220 where the transaction is authorized. The authorization may be sent from the bank to the vendor requesting the authorization. In addition, the customer's credit card account information may be updated to reflect the transaction at the bank. For example, if a single use credit card number was used in optional step 210, the bank may note the single use credit card number in the credit card account so that the same credit card number is not issued again for single use. The method then proceeds to step 222 where the method 200 ends.

However, if the PIN is not valid (e.g., any one of the parameters associated with the PIN are not met) at step 216, the method 200 proceeds to step 218 where the transaction is denied. The method then proceeds to step 222 where the method 200 ends.

It should be noted that although not explicitly specified, one or more steps, functions, or operations of the method 200 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 2 that recite a determining operation, or involve a decision, do not necessarily require that both branches of the determining operation be practiced. In other words, one of the branches of the determining operation can be deemed as an optional step.

FIG. 3 depicts a high-level block diagram of a general-purpose computer suitable for use in performing the functions described herein. As depicted in FIG. 3, the system 300 comprises a processor element 302 (e.g., a CPU), a memory 304, e.g., random access memory (RAM) and/or read only memory (ROM), a module 305 for authorizing a credit card transaction, and various input/output devices 306 (e.g., storage devices, including but not limited to, a tape drive, a floppy drive, a hard disk drive or a compact disk drive, a receiver, a transmitter, a speaker, a display, a speech synthesizer, an output device (such as a graphic display, printer, and the like), an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps of the above disclosed methods. In one embodiment, the present module or process 305 for authorizing a credit card transaction can be loaded into memory 304 and executed by processor 302 to implement the functions as discussed above. As such, the present method 305 for authorizing a credit card transaction (including associated data structures) of the present disclosure can be stored on a non-transitory (e.g., physical and tangible) computer readable storage medium, e.g., RAM memory, magnetic or optical drive or diskette and the like. For example, the hardware processor 302 can be programmed or configured with instructions (e.g., computer readable instructions) to perform the steps, functions, or operations of method 200.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for authorizing a website transaction, comprising:
receiving, by a processor of a server at a bank, a request from an endpoint device of a user to generate a vendor specific personal identification number (PIN) for a credit card account issued by the bank and associated with the user;
establishing, by the processor, the vendor specific PIN for each one of a plurality of different vendors, wherein the vendor specific PIN is selected by the user and is different for the each one of the plurality of different vendors, wherein the vendor specific PIN is associated with one or more parameters defined by the user comprising at least one authorized user of the credit card account and an authorized time range;
receiving, by the processor, a request from a vendor to validate the website transaction with the vendor using the credit card account;
sending, by the processor, a request to the user of the credit card account for the vendor specific PIN associated with the credit card account, wherein the request is sent to the endpoint device of the user via at least one of: an email, a text message, a push notification or a telephone call;
receiving, by the processor, the vendor specific PIN via the endpoint device of the user;
determining, by the processor, that the vendor specific PIN received from the endpoint device of the user matches the vendor specific PIN that was established and associated with the credit card account, that the user is one of the at least one authorized user and that the website transaction is within the authorized time range; and
authorizing, by the processor, the website transaction with the vendor using the credit card account.

2. The method of claim 1, further comprising:
denying, by the processor, the website transaction with the vendor using the credit card account when any one of the one or more parameters associated with the vendor specific PIN is not met by the website transaction and the vendor.

3. The method of claim 1, further comprising:
generating, by the processor, a single use credit card number associated with the credit card account;
receiving, by the processor, the single use credit card number with the request to validate the website transaction with the vendor; and
determining, by the processor, that the single use credit card number has never been used in a previous transaction in association with the credit card account before authorizing the website transaction with the vendor.

4. The method of claim 3, further comprising:
denying, by the processor, the website transaction with the vendor when the single use credit card number has been used before in association with the credit card account.

5. (canceled)

6. (canceled)

7. (canceled)

8. The method of claim 1, wherein the website transaction is a customer not present (CNP) transaction.

9. (canceled)

10. A non-transitory computer-readable medium storing a plurality of instructions which, when executed by a processor of a server at a bank, cause the processor to perform operations for authorizing a website transaction, the operations comprising:
receiving a request from an endpoint device of a user to generate a vendor specific personal identification number (PIN) for a credit card account issued by the bank and associated with the user;
establishing the vendor specific PIN for each one of a plurality of different vendors, wherein the vendor specific PIN is selected by the user and is different for the each one of the plurality of different vendors, wherein the vendor specific PIN is associated with one or more parameters defined by the user comprising at least one authorized user of the credit card account and an authorized time range;
receiving a request from a vendor to validate the website transaction with the vendor using the credit card account;
sending a request to the user of the credit card account for the vendor specific PIN associated with the credit card account, wherein the request is sent to the endpoint device of the user via at least one of: an email, a text message, a push notification or a telephone call;
receiving the vendor specific PIN via the endpoint device of the user;
determining that the vendor specific PIN received from the endpoint device of the user matches the vendor specific PIN that was established and associated with the credit card account, that the user is one of the at least one authorized user and that the website transaction is within the authorized time range; and
authorizing the website transaction with the vendor using the credit card account.

11. The non-transitory computer-readable medium of claim 10, further comprising:
denying the website transaction with the vendor using the credit card account when any one of the one or more parameters associated with the vendor specific PIN is not met by the website transaction and the vendor.

12. The non-transitory computer-readable medium of claim 10, further comprising:
generating a single use credit card number associated with the credit card account;
receiving the single use credit card number with the request to validate the website transaction with the vendor; and
determining that the single use credit card number has never been used in a previous transaction in association with the credit card account before authorizing the website transaction with the vendor.

13. The non-transitory computer-readable medium of claim 12, further comprising:
denying the website transaction with the vendor when the single use credit card number has been used before in association with the credit card account.

14. (canceled)

15. (canceled)

16. (canceled)

17. The non-transitory computer-readable medium of claim 10, wherein the website transaction is a customer not present (CNP) transaction.

18. (canceled)

19. (canceled)

20. (canceled)
